(19) United States
(12) Patent Application Publication
(10) Pub. No.: US 2016/0373948 A1
(43) Pub. Date: Dec. 22, 2016

(54) PERFORMING INTER-FREQUENCY AND INTER RADIO ACCESS TECHNOLOGY MEASUREMENTS IN A MULTI SUBSCRIBER IDENTITY MODULE MULTI ACTIVE MOBILE COMMUNICATION DEVICE

(71) Applicant: QUALCOMM Incorporated, San Diego, CA (US)

(72) Inventors: Suresh Sanka, Hyderabad (IN); Mukesh Kumar, Hyderabad (IN); Nilotpal Dhar, Hyderabad (IN)

(21) Appl. No.: 14/743,784

(22) Filed: Jun. 18, 2015

(51) Int. Cl. H04W 24/08; H04W 8/18

(52) U.S. Cl. CPC H04W 24/08; H04W 8/183; H04W 88/06

(57) ABSTRACT

A method for performing one or more measurements by a mobile communication device having a first radio-frequency (RF) chain associated with a first subscription and a second RF chain associated with a second subscription includes: determining that the mobile communication device is in a connected mode on the first subscription; determining whether the second RF chain associated with the second subscription is available; and in response to determining that the second RF chain associated with the second subscription is available, utilizing the second RF chain associated with the second subscription to perform at least one of an inter-frequency measurement and an inter-radio access technology measurement on the first subscription.

### BACKGROUND

A multi-subscriber identity module (SIM) multi-active (MSMA) mobile communication device may have multiple radio frequency (RF) chains to support activities on different subscriptions. When the MSMA mobile communication device is in a connected mode (e.g., engaged in a voice call or a data call) on one subscription, one RF chain may be tuned to a particular carrier frequency. In order to also support handovers on the connected mode subscription, a conventional MSMA mobile communication device may use the same RF chain to perform inter-frequency and/or inter-radio access technology (RAT) measurements on the connected mode subscription.

A conventional MSMA mobile communication device may operate in compressed mode (CM) on the connected mode subscription in order to perform measurements (e.g., inter-frequency, inter-RAT) on the connected mode subscription. When CM is enabled on the connected mode subscription, gaps may be placed during the transmissions (e.g., uplink or downlink) on the connected mode subscription. The MSMA mobile communication device may perform measurements (e.g., inter-frequency, inter-RAT) during the transmission gaps on the connected mode transmission.

However, operating in CM may degrade voice call quality (e.g., based on a mean opinion score (MOS)) and data throughput on the connected mode subscription. Moreover, CM operation may elevate power consumption as the MSMA mobile communication device may increase transmission power during CM operation in order to maintain voice call quality (e.g., MOS).

### SUMMARY

Apparatuses and methods for performing inter-frequency and inter-RAT measurements in a MSMA mobile communication device are provided.

According to the various embodiments, there is provided a method for performing one or more measurements by a mobile communication device having a first RF chain associated with a first subscription and a second RF chain associated with a second subscription. The method may include: determining that the mobile communication device is in a connected mode on the first subscription; determining whether the second RF chain associated with the second subscription is available; and in response to determining that the second RF chain associated with the second subscription is available, utilizing the second RF chain associated with the second subscription to perform at least one of an inter-frequency measurement and an inter-RAT measurement on the first subscription.

According to the various embodiments, there is provided a mobile communication device. In some embodiments, the mobile communication device may include a control unit, a first RF chain associated with a first subscription, and a second RF chain associated with a second subscription.

The control unit may be configured to: determine that the mobile communication device is in a connected mode on the first subscription; determine whether the second RF chain associated with the second subscription is available; and in response to determining that the second RF chain associated with the second subscription is available, utilize the second RF chain associated with the second subscription to perform at least one of an inter-frequency measurement and an inter-RAT measurement on the first subscription.

According to various embodiments, there is provided a mobile communication device. In some embodiments, the mobile communication device may include: means for determining that the mobile communication device is in a connected mode on a first subscription; means for determining whether a second RF chain associated with a second subscription is available; and in response to determining that the second RF chain associated with the second subscription is available, means for utilizing the second RF chain associated with the second subscription to perform at least one of an inter-frequency measurement and an inter-RAT measurement on the first subscription.

According to various embodiments, there is provided a non-transitory computer readable medium. In some embodiments, the non-transitory computer readable medium may have stored thereon instructions for causing one or more processors to perform operations comprising: determining that a mobile communication device is in a connected mode on a first subscription; determining whether a second RF chain associated with a second subscription is available; and in response to determining that the second RF chain associated with the second subscription is available, utilizing the second RF chain associated with the second subscription to perform at least one of an inter-frequency measurement and an inter-RAT measurement on the first subscription.

Other features and advantages of the present inventive concept should be apparent from the following description which illustrates by way of example aspects of the present inventive concept.

### BRIEF DESCRIPTION OF THE DRAWINGS

Aspects and features of the present inventive concept will be more apparent by describing example embodiments with reference to the accompanying drawings, in which:

FIG. 1 is a block diagram illustrating a mobile communication device according to various embodiments;

FIG. 2 is a flowchart illustrating a process for performing one or more measurements according to various embodiments;

FIG. 3 is a flowchart illustrating a process for determining an availability of an RF chain according to various embodiments;

FIG. 4 is a flowchart illustrating a process for determining a presence of transmission gaps according to various embodiments; and

FIG. 5 is an event diagram illustrating a sequence for performing one or more measurements according to various embodiments.

### DETAILED DESCRIPTION

While a number of embodiments are described herein, these embodiments are presented by way of example only, and are not intended to limit the scope of protection. The apparatuses and methods described herein may be embodied in a variety of other forms. Furthermore, various omissions, substitutions, and changes in the form of the example apparatuses and methods described herein may be made without departing from the scope of protection.

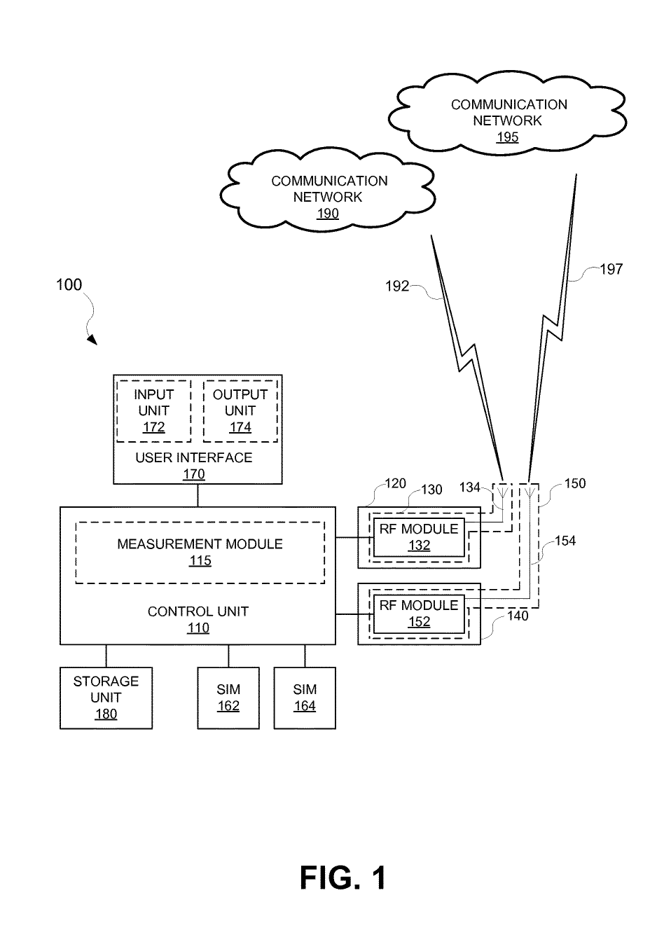

FIG. 1 is a block diagram illustrating a mobile communication device 100 according to various embodiments. Referring to FIGS. 1, in various embodiments, the mobile communication device 100 may include a control unit 110, a first communication unit 120, a second communication unit 140, a first SIM 162, a second SIM 164, a user interface 170, and storage unit 180.

In various embodiments, the mobile communication device 100 may be any device capable of wirelessly communicating with one or more communication networks including, for example, but not limited to, a first communication network 190 and a second communication network 195. In various embodiments, the mobile communication device 100 may be, for example, but not limited to, a smartphone, a tablet PC, or a laptop computer.

A SIM (for example the first SIM 162 and/or the second SIM 164) in various embodiments may be a Universal Integrated Circuit Card (UICC) that is configured with SIM and/or Universal SIM (USIM) applications, enabling access to Global System for Mobile communications (GSM) and/or Universal Mobile Telecommunications System (UMTS) networks. The UICC may also provide storage for a phone book and other applications. Alternatively, in a Code Division Multiple Access (CDMA) network, a SIM may be a UICC removable user identity module (R-UIM) or a CDMA subscriber identity module (CSIM) on a card. A SIM card may have a CPU, ROM, RAM, EEPROM and I/O circuits. An Integrated Circuit Card Identity (ICCID) SIM serial number may be printed on the SIM card for identification. However, a SIM may be implemented within a portion of memory of the mobile communication device 100, and thus need not be a separate or removable circuit, chip, or card.

A SIM used in various embodiments may store user account information, an International Mobile Subscriber Identity (IMSI), a set of SIM application toolkit (SAT) commands, and other network provisioning information, as well as provide storage space for phone book database of the user's contacts. As part of the network provisioning information, a SIM may store home identifiers (e.g., a System Identification Number (SID)/Network Identification Number (NID) pair, a Home Public Land Mobile Network (HPLMN) code, etc.) to indicate the SIM card network operator provider.

In various embodiments, the first communication unit 120 may include a first RF chain 130. The first RF chain 130 may include, for example, but not limited to, a first RF module 132 and a first antenna 134.

In various embodiments, the second communication unit 140 may include a second RF chain 150. The second RF chain 150 may include, for example, but not limited to, a second RF module 152 and a second antenna 154.

Although the mobile communication device 100 is shown to include the first communication unit 120 and the second communication unit 140, a person of ordinary skill in the art can appreciate that the mobile communication device 100 may include additional communication units without departing from the scope of the present inventive concept.

In various embodiments, the first SIM 162 may associate the first communication unit 120 with a first subscription 192 on the first communication network 190, and the second SIM 164 may associate the second communication unit 140 with a second subscription 197 on the second communication network 195. For clarity and convenience, throughout this disclosure, the first subscription 192 is associated with the first communication unit 120 while the second subscription 197 is associated with the second communication unit 140. However, a person having ordinary skill in the art can appreciate that either subscription may be associated with either communication unit without departing from the scope of the present inventive concept.

In various embodiments, the first communication network 190 and the second communication network 195 may be operated by the same or different mobile service providers (MSPs). Additionally, in various embodiments, the first communication network 190 and the second communication network 195 may each implement the same or different RATs, including, for example, but not limited to Wideband CDMA(WCDMA), GSM, Long Term Evolution (LTE), and Time Division-Synchronous Code Division Multiple Access (TD-SCDMA).

In various embodiments, the user interface 170 may include an input unit 172. In some embodiments, the input unit 172 may be, for example, but not limited to, a keyboard or a touch panel. In various embodiments, the user interface 170 may include an output unit 174. In some embodiments, the output unit 174 may be, for example, but not limited to, a liquid crystal display (LCD) or a light emitting diode (LED) display. A person of ordinary skill in the art will appreciate that other types or forms of input and output units may be used without departing from the scope of the present inventive concept.

In various embodiments, the control unit 110 may be configured to control the overall operation of the mobile communication device 100 including controlling the functions of the first communication unit 120 and the second communication unit 140. In various embodiments, the control unit 110 may include a measurement module 115 configured to perform one or more measurements on the first subscription 192 and the second subscription 197. For example, the measurement module 115 may be configured to perform inter-frequency and/or inter-RAT measurements for one or more neighbor cells. In various embodiments, the control unit 110 may be, for example, but not limited to, a microprocessor (e.g., general-purpose processor, baseband modem processor, etc.) or a microcontroller.

In various embodiments, the storage unit 180 may be configured to store application programs, application data, and user data. In various embodiments, at least some of the application programs stored at the storage unit 180 may be executed by the control unit 110 for the operation of the mobile communication device 100.

In various embodiments, the control unit 110 may be configured to utilize the first RF chain 130 to engage in a voice call or a data call on the first subscription 192. To support handovers on the first subscription 192, the control unit 110 may utilize the second RF chain 150 associated with the second subscription 197 to perform inter-frequency and/or inter-RAT measurements for one or more neighbor cells on the first subscription 192. As such, the mobile communication device 100 may not be required to operate in CM on the first subscription 192.

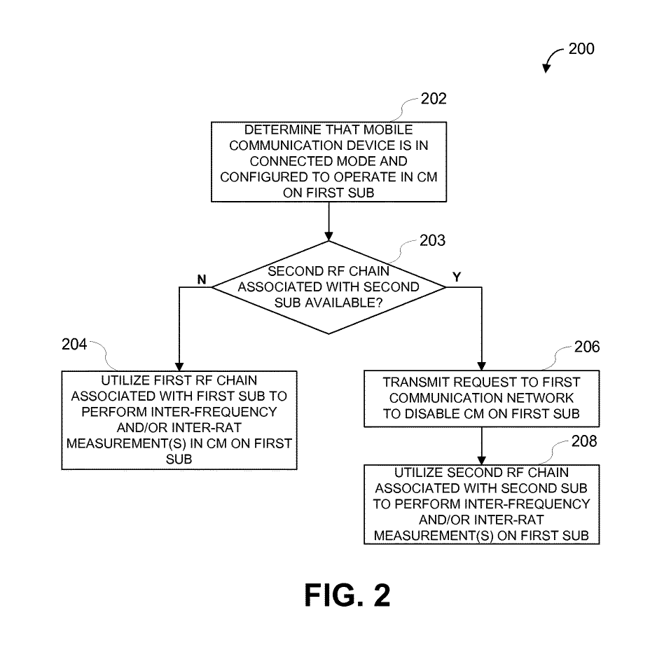

FIG. 2 is a flowchart illustrating a process 200 for performing one or more measurements according to various embodiments. With references to FIGS. 1 and 2, in various embodiments, the process 200 may be performed by the control unit 110, for example, by the measurement module 115.

The control unit 110 may determine that the mobile communication device 100 is in a connected mode and configured to operate in CM on the first subscription 192 (202). For example, the mobile communication device 100 may be engaged in a voice call or a data call on the first subscription 192. As such, the mobile communication device 100 may be configured to operate in CM mode on the first subscription 192 by default.

The control unit 110 may determine whether the second RF chain 150 associated with the second subscription 197 is available (203). For example, the control unit 110 may determine whether the second RF chain 150 associated with the second subscription 197 may be available to perform inter-frequency and/or inter-RAT measurements for one or more neighbor cells on the first subscription 192.

The control unit 110 may determine that the second RF chain 150 associated with the second subscription 197 is not available (203-N). As such, the mobile communication device 100 may operate in CM on the first subscription 192 in order to allow the control unit 110 to utilize the first RF chain 130 associated with the first subscription 192 to perform at least one of an inter-frequency measurement and an inter-RAT measurement in CM on the first subscription 192 (204). For example, the control unit 110 may utilize the first RF chain 130 to perform inter-frequency and/or inter-RAT measurements for one or more neighbor cells during CM transmission gaps on the first subscription 192.

Alternately, the control unit 110 may determine that the second RF chain 150 associated with the second subscription 197 is available (203-Y). For example, the second RF chain 150 associated with the second subscription 197 may be available to perform inter-frequency and/or inter-RAT measurements for one or more neighbor cells on the first subscription 192.

Accordingly, the control unit 110 may transmit a request to the first communication network 190 to disable CM on the first subscription 192 (206).

For example, the control unit 110 may transmit a user equipment (UE) capability information message to the first communication network 190 indicating that CM is not required on the first subscription 192. In response to the UE capability information message, the first communication network 190 may transmit a UE capability information confirm message to the mobile communication device 100. The UE capability information confirm message may indicate to the mobile communication device 100 that CM is disabled on the first subscription 192.

The control unit 110 may utilize the second RF chain 150 associated with the second subscription 197 to perform at least one of an inter-frequency measurement and an inter-RAT measurement on the first subscription 192 (208). For example, while the control unit 110 utilizes the first RF chain 130 associated with the first subscription 192 to engage in a voice call or a data call on the first subscription 192, the control unit 110 may utilize the second RF chain 150 associated with the second subscription 197 to perform inter-frequency and/or inter-RAT measurements for one or more neighbor cells on the first subscription 192.

As such, the mobile communication device 100 may disable CM on the first subscription 192. The control unit 110 may utilize the second RF chain 150 associated with the second subscription 197 to perform inter-frequency and/or inter-RAT measurements for one or more neighbor cells on the first subscription 192.

Although the mobile communication device 100 is described to be in a connected mode on the first subscription 192 in the process 200, a person having ordinary skill in the art can appreciate that the mobile communication device 100 may be in a connected mode on a different subscription without departing from the scope of the present inventive concept.

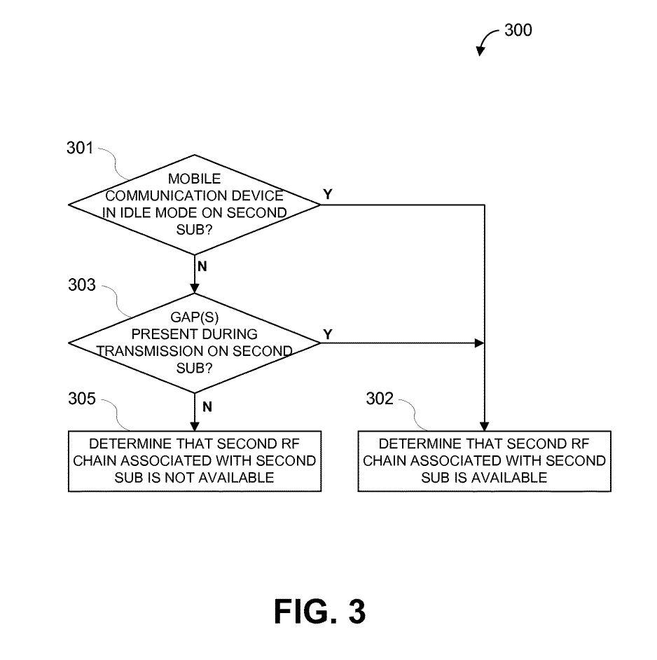

FIG. 3 is a flowchart illustrating a process 300 for determining an availability of an RF chain according to various embodiments. With references to FIGS. 1-3, in various embodiments, the process 300 may be performed by the control unit 110, for example, by the measurement module 115 and may implement operation 203 of the process 200.

The control unit 110 may determine whether the mobile communication device 100 is in an idle mode on the second subscription 197 (301). When the mobile communication device 100 is in the idle mode on the second subscription 197, the control unit 110 may periodically utilize the second RF chain 150 to perform idle mode operations for the second subscription 197. For example, the control unit 110 may utilize the second RF chain 150 to receive paging messages from the second communication network 195 according to a discontinuous reception (DRx) schedule. Thus, while the control unit 110 is not utilizing the second RF chain 150 to perform idle mode operations on the second subscription 197, the control unit 110 may utilize the second RF chain 150 to perform inter-frequency and/or inter-RAT measurements for one or more neighbor cells on the first subscription 192.

Accordingly, if the control unit 110 determines that mobile communication device 100 is in the idle mode on the second subscription 197 (301-Y), the control unit 110 may determine that the second RF chain 150 associated with the second subscription 197 is available (302). For example, the control unit 110 may determine that the second RF chain 150 associated with the second subscription 197 is available to perform inter-frequency and/or inter-RAT measurements for one or more neighbor cells on the first subscription 192. The control unit 110 may then proceed, for example, with the operations 206 and/or 208.

Alternately, if the control unit 110 determines that the mobile communication device 100 is not in an idle mode on the second subscription 197 (301-N), the control unit 110 may determine whether one or more gaps are present during a transmission on the second subscription 197 (303). For example, the control unit 110 may determine that the mobile communication device 100 is in a connected mode (e.g., engaged in a voice call or a data call) on the second subscription 197. Nevertheless, one or more gaps may be present during the transmission of voice data or packet switched (PS) data on the second subscription 197. The control unit 110 may utilize the second RF chain 150 associated with the second subscription 197 during the transmission gaps on the second subscription 197 to perform inter-frequency and/or inter-RAT measurements for one or more neighbor cells on the first subscription 192.

If the control unit 110 determines that one or more gaps are present during the transmission on the second subscription 197 (303-Y), the control unit 110 may determine that the second RF chain 150 associated with the second subscription 197 is available (302). For example, the control unit 110 may determine that the second RF chain 150 associated with the second subscription 197 is available to perform inter-frequency and/or inter-RAT measurements for one or more neighbor cells on the first subscription 192.

In contrast, if the control unit 110 determines that one or more gaps are not present during the transmission on the second subscription 197 (303-N), the control unit 110 may determine that the second RF chain 150 associated with the second subscription 197 is not available (305). For example, the control unit 110 may determine that the second RF chain 150 associated with the second subscription 197 is not available to perform inter-frequency and/or inter-RAT measurements for one or more neighbor cells on the first subscription 192.

Although the process 300 is described with respect to the second subscription 197, a person having ordinary skill in the art can appreciate that the process 300 may also be performed with respect to the first subscription 192 without departing from the scope of the present inventive concept.

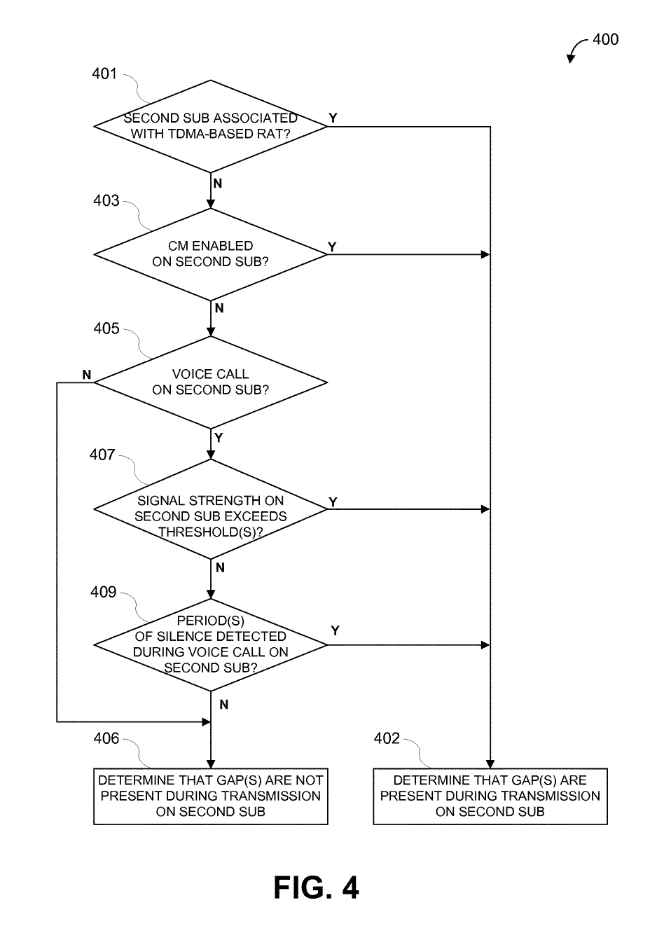

FIG. 4 is a flowchart illustrating a process 400 for determining a presence of transmission gaps according to various embodiments. With references to FIGS. 1-4, in various embodiments, the process 400 may be performed by the control unit 110, for example, by the measurement module 115. The process 400 may implement the operation 303 of the process 300.

The control unit 110 may determine whether the second subscription 197 is associated with a time division multiple access (TDMA) based RAT (401). For example, the control unit 110 may determine whether the second communication network 195 that is associated with the second subscription 197 implements a TDMA-based RAT (e.g., GSM).

In a communication network that implements a TDMA-based RAT (e.g., GSM), data for different users may be transmitted in alternating timeslots on the same carrier frequency. The data (e.g., voice data, PS data) for each user is transmitted in a non-continuous manner during the time slots assigned to the user. Thus, one or more gaps may be present in transmissions on the second subscription 197 if the second subscription 197 is associated with a TDMA-based RAT (e.g., GSM).

If the control unit 110 determines that the second subscription 197 is associated with a TDMA-based RAT (401-Y), the control unit 110 may determine that one or more gaps are present during the transmission on the second subscription 197 (402).

Alternately, if the control unit 110 determines that the second subscription 197 is not associated with a TDMA-based RAT (401-N), the control unit 110 may determine whether CM is enabled on the second subscription 197 (403). For example, the mobile communication device 100 may be in a connected mode (e.g., engaged in a voice call or a data call) on the second subscription 197. As such, CM may be enabled on the second subscription 197 in order to perform inter-frequency and/or inter-RAT measurements for one or more neighbor cells and to support handovers on the second subscription 197.

When CM is enabled on the second subscription 197, the control unit 110 may utilize the second RF chain 150 to perform inter-frequency and inter-RAT measurements for one or more neighbor cells on the second subscription 197 during some of the transmission gaps on the second subscription 197. However, during other transmission gaps on the second subscription 197, the control unit 110 may utilize the second RF chain 150 associated with the second subscription 197 to perform inter-frequency and/or inter-RAT measurements for one or more neighbor cells on the first subscription 192. Thus, if the control unit 110 determines that CM is enabled on the second subscription 197 (403-Y), the control unit 110 may determine that one or more gaps are present during the transmission on the second subscription 197 (402).

Alternately, if the control unit 110 determines that CM is not enabled on the second subscription 197 (403-N), the control unit 110 may determine whether the mobile communication device 100 is engaged in a voice call on the second subscription 197 (403). If the control unit 110 determines that the mobile communication device 100 is not engaged in a voice call on the second subscription 197 (405-N), the control unit 110 may determine that one or more gaps are not present during the transmission on the second subscription 197 (406).

Alternately, if the control unit 110 determines that the mobile communication device 100 is engaged in a voice call on the second subscription 197 (405-Y), the control unit 110 may determine whether a strength of a signal on the second subscription 197 exceeds one or more thresholds (407). For example, the control unit 110 may measure one or more received signal strength indicators (RSSIs) (e.g., received signal level (RxLev), received signal quality (RxQual)) of a signal received on the second subscription 197 and determine whether the one or more RSSIs exceed corresponding thresholds.

During a voice call on the second subscription 197, the control unit 110 may be allotted a certain period of time to utilize the second RF chain 150 associated with the second subscription 197 to receive each individual voice frame. If the signal strength on the second subscription 197 exceeds one or more thresholds, the control unit 110 may be able to successfully decode partially received voice frames. Thus, the control unit 110 may require only a portion of the allotted time period to utilize the second RF chain 150 to receive the voice frame. The remainder of the allotted time period may be a transmission gap on the second subscription 197 during which the control unit 110 may utilize the second RF chain 150 to perform inter-frequency and/or inter-RAT measurements for one or more neighbor cells on the first subscription 192.

Accordingly, if the control unit 110 determines that the signal strength on the second subscription 197 exceeds one or more thresholds (407-Y), the control unit 110 may determine that one or more gaps are present during the transmission on the second subscription 197 (402). However, if the control unit 110 determines that the signal strength on the second subscription 197 does not exceed one or more thresholds (407-N), the control unit 110 may determine whether one or more periods of silence are detected during the voice call on the second subscription 197 (409). For example, the control unit 110 may detect a silence indicator (SID) packet set by the second communication network 195 on the second subscription 197.

If the control unit 110 determines that one or more periods of silence are detected during the voice call on the second subscription 197 (409-Y), the control unit 110 may determine that one or more gaps are present during the transmission on the second subscription 197 (402). Alternately, if the control unit 110 determines that one or more periods of silence are not detected during the voice call on the second subscription 197 (409-N), the control unit 110 may determine that one or more gaps are not present during the transmission on the second subscription 197 (406).

Although the process 400 is described with respect to the second subscription 197, a person having ordinary skill in the art can appreciate that the process 400 may also be performed with respect to the first subscription 192 without departing from the scope of the present inventive concept.

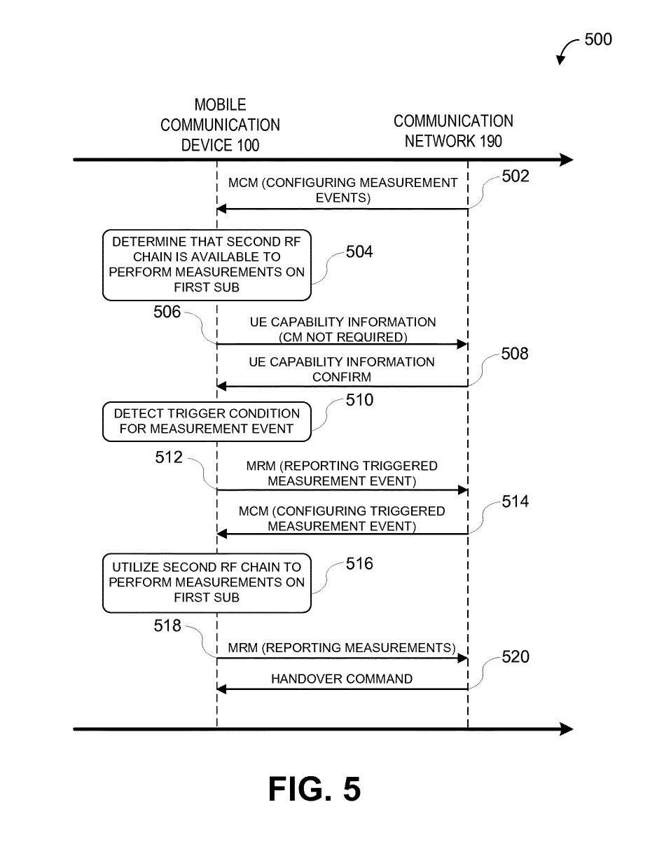

FIG. 5 is an event diagram illustrating a sequence 500 for performing one or more measurements according to various embodiments. Referring to FIGS. 1-5, the mobile communication device 100 may be in a connected mode on the first subscription 192. For example, the mobile communication device 100 may be engaged in a voice call or a data call on the first subscription 192. As such, the mobile communication device 100 may be exchanging voice data or PS data with the first communication network 190.

In the sequence 500, the mobile communication device may receive a measurement control message (MCM) from the first communication network 190 (502). The MCM may include configurations for one or more measurement events. For example, the first communication network 190 may transmit an MCM that configures the mobile communication device 100 to perform one or more inter-frequency measurements when an energy of a current serving cell on the first subscription 192 is below one or more thresholds.

The mobile communication device 100 may determine that the second RF chain 150 associated with the second subscription 197 is available to perform one or more measurements (e.g., inter-frequency, inter-RAT) on the first subscription 192 (504). For example, the mobile communication device 100 may determine that the second RF chain 150 associated with the second subscription 197 is available to perform inter-frequency and/or inter-RAT measurements for one or more neighbor cells on the first subscription 192. Thus, the mobile communication device 100 may transmit an UE capability information message to the first communication network 190 (506). The UE capability information message may indicate to the first communication network 190 that CM is not required to be enabled on the first subscription 192.

In response to the UE capability information message from the mobile communication device 100, the mobile communication device 100 may receive a UE capability information confirm message from the first communication network 190 (508). The UE capability information confirm message may indicate to the mobile communication device 100 that CM is disabled on the first subscription 192.

The mobile communication device 100 may detect a trigger condition for a measurement event (510). For example, the mobile communication device 100 may determine that an energy of the current serving cell on the first subscription 192 is below one or more thresholds. In response, the mobile communication device 100 may trigger an inter-frequency and/or inter-RAT measurement event. Furthermore, the mobile communication device 100 may transmit a measurement report message (MRM) to the first communication network 190 reporting the triggered measurement event (512).

In response to the MRM from the mobile communication device 100, the mobile communication device 100 may receive an MCM from the first communication network 190 (514). The MCM may include configurations for the triggered measurement event. For example, the first communication network 190 may transmit an MCM to the mobile communication device 100 identifying one or more inter-frequency and/or inter-RAT neighbor cells.

The mobile communication device 100 may utilize the second RF chain 150 to perform one or more measurements (e.g., inter-frequency, inter-RAT) on the first subscription 192 (516). For example, the mobile communication device 100 may utilize the second RF chain 150 to perform inter-frequency and/or inter-RAT measurements for one or more neighbor cells identified in the MCM received from the first communication network 190.

The mobile communication device 100 may transmit an MRM to the first communication network 190 reporting the one or more measurements (e.g., inter-frequency, inter-RAT) (518). For example, the mobile communication device 100 may transmit an MRM to the first communication network 190 reporting the measured signal strength for one or more inter-frequency and/or inter-RAT neighbor cells.

In response to the MRM from the mobile communication device 100, the mobile communication device 100 may receive a handover command from the first communication network 190 (520). For example, the first communication network 190 may determine, based on the inter-frequency or inter-RAT measurement reported in the MRM, that a signal strength of a neighbor cell does exceed one or more thresholds. Thus, the mobile communication device 100 may receive from the first communication network 190 a handover command to execute a handover to the inter-frequency or inter-RAT neighbor cell on the first subscription 192.

Although the sequence 500 is described with respect to the first subscription 192, a person having ordinary skill in the art can appreciate that the sequence 500 may also transpire on the second subscription 197 without departing from the scope of the present inventive concept.

The accompanying claims and their equivalents are intended to cover such forms or modifications as would fall within the scope and spirit of the protection. For example, the example apparatuses, methods, and systems disclosed herein may be applied to multi-SIM wireless devices subscribing to multiple communication networks and/or communication technologies. The various components illustrated in the figures may be implemented as, for example, but not limited to, software and/or firmware on a processor, ASIC/FPGA/DSP, or dedicated hardware. Also, the features and attributes of the specific example embodiments disclosed above may be combined in different ways to form additional embodiments, all of which fall within the scope of the present disclosure.

The foregoing method descriptions and the process flow diagrams are provided merely as illustrative examples and are not intended to require or imply that the operations of the various embodiments must be performed in the order presented. As will be appreciated by one of skill in the art the order of operations in the foregoing embodiments may be performed in any order. Words such as “thereafter,” “then,” “next,” etc., are not intended to limit the order of the operations; these words are simply used to guide the reader through the description of the methods. Further, any reference to claim elements in the singular, for example, using the articles “a,” “an,” or “the” is not to be construed as limiting the element to the singular.

The various illustrative logical blocks, modules, circuits, and operations described in connection with the embodiments disclosed herein may be implemented as electronic hardware, computer software, or combinations of both. To clearly illustrate this interchangeability of hardware and software, various illustrative components, blocks, modules, circuits, and operations have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present inventive concept.

The hardware used to implement the various illustrative logics, logical blocks, modules, and circuits described in connection with the various embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of receiver devices, e.g., a combination of a DSP and a microprocessor, a plurality of microprocessors, one or more microprocessors in conjunction with a DSP core, or any other such configuration. Alternatively, some operations or methods may be performed by circuitry that is specific to a given function.

In one or more exemplary embodiments, the functions described may be implemented in hardware, software, firmware, or any combination thereof. If implemented in software, the functions may be stored as one or more instructions or code on a non-transitory computer-readable storage medium or non-transitory processor-readable storage medium. The operations of a method or algorithm disclosed herein may be embodied in processor-executable instructions that may reside on a non-transitory computer-readable or processor-readable storage medium. Non-transitory computer-readable or processor-readable storage media may be any storage media that may be accessed by a computer or a processor. By way of example but not limitation, such non-transitory computer-readable or processor-readable storage media may include random access memory (RAM), read-only memory (ROM), electrically erasable programmable read-only memory (EEPROM), FLASH memory, CD-ROM or other optical disk storage, magnetic disk storage or other magnetic storage devices, or any other medium that may be used to store desired program code in the form of instructions or data structures and that may be accessed by a computer. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above are also included within the scope of non-transitory computer-readable and processor-readable media. Additionally, the operations of a method or algorithm may reside as one or any combination or set of codes and/or instructions on a non-transitory processor-readable storage medium and/or computer-readable storage medium, which may be incorporated into a computer program product.

Although the present disclosure provides certain example embodiments and applications, other embodiments that are apparent to those of ordinary skill in the art, including embodiments which do not provide all of the features and advantages set forth herein, are also within the scope of this disclosure. Accordingly, the scope of the present disclosure is intended to be defined only by reference to the appended claims.

What is claimed is:

1. A method for performing one or more measurements by a mobile communication device having a first radio-frequency (RF) chain associated with a first subscription and a second RF chain associated with a second subscription, comprising:
determining that the mobile communication device is in a connected mode on the first subscription;
determining whether the second RF chain associated with the second subscription is available; and
in response to determining that the second RF chain associated with the second subscription is available, utilizing the second RF chain associated with the second subscription to perform at least one of an inter-frequency measurement and an inter-radio access technology (RAT) measurement on the first subscription.

2. The method of claim 1, further comprising determining that the mobile communication device is configured to operate in compressed mode (CM) on the first subscription.

3. The method of claim 1, wherein the at least one of the inter-frequency measurement and inter-RAT measurement comprises a measurement of a strength of a signal for an inter-frequency neighbor cell or an inter-RAT neighbor cell on the first subscription.

4. The method of claim 1, further comprising:
in response to determining that the second RF chain associated with the second subscription is available, transmitting a request to a first communication network to disable compressed mode (CM) on the first subscription.

5. The method of claim 1, further comprising:
in response to determining that the second RF chain associated with the second subscription is not available, utilizing the first RF chain associated with the first subscription to perform at least one of the inter-frequency measurement and the inter-RAT measurement on the first subscription.

6. The method of claim 1, wherein determining whether the second RF chain associated with the second subscription is available comprises:
determining whether the second subscription is in an idle mode; and
in response to determining that the second subscription is in the idle mode, determining that the second RF chain associated with the second subscription is available.

7. The method of claim 6, further comprising:
in response to determining that the second subscription is not in the idle mode, determining whether one or more gaps are present during a transmission on the second subscription; and
in response to determining that the one or more gaps are present during the transmission on the second subscription, determining that the second RF chain associated with the second subscription is available.

8. The method of claim 7, wherein determining whether one or more gaps are present during a transmission on the second subscription comprises:
determining whether the second subscription is associated with a time division multiple access (TDMA) based RAT; and
in response to determining that the second subscription is associated with the TDMA-based RAT, determining that the one or more gaps are present during the transmission on the second subscription.

9. The method of claim 8, further comprising:
in response to determining that the second subscription is not associated with the TDMA-based RAT, determining whether compressed mode (CM) is enabled on the second subscription; and
in response to determining that CM is enabled on the second subscription, determining that the one or more gaps are present during the transmission on the second subscription.

10. The method of claim 9, further comprising:
in response to determining that CM is not enabled on the second subscription, determining whether the second subscription is engaged in a voice call; and
in response to determining that the second subscription is engaged in the voice call, determining whether a strength of a signal on the second subscription exceeds one or more thresholds; and
in response to determining that the signal strength on the second subscription exceeds the one or more thresholds, determining that the one or more gaps are present during the transmission on the second subscription.

11. The method of claim 10, further comprising:
in response to determining that the second subscription is not engaged in the voice call, determining that the one or more gaps are not present during the transmission on the second subscription.

12. The method of claim 10, further comprising:
in response to determining that the signal strength on the second subscription does not exceed the one or more thresholds, determining whether one or more periods of silence are detected during the voice call on the second subscription; and
in response to determining that the one or more periods of silence are detected during the voice call on the second subscription, determining that the one or more gaps are present during the transmission on the second subscription.

13. The method of claim 12, further comprising:
in response to determining that the one or more periods of silence are not detected during the voice call on the second subscription, determining that the one or more gaps are not present during the transmission on the second subscription.

14. The method of claim 7, wherein determining whether one or more gaps are present during a transmission on the second subscription comprises:
determining whether compressed mode (CM) is enabled on the second subscription; and
in response to determining that CM is enabled on the second subscription, determining that the one or more gaps are present during the transmission on the second subscription.

15. The method of claim 7, wherein determining whether one or more gaps are present during a transmission on the second subscription comprises:
determining whether the second subscription is engaged in a voice call; and
in response to determining that the second subscription is engaged in the voice call, determining whether a strength of a signal on the second subscription exceeds one or more thresholds; and
in response to determining that the signal strength on the second subscription exceeds the one or more thresholds, determining that the one or more gaps are present during the transmission on the second subscription.

16. The method of claim 7, wherein determining whether one or more gaps are present during a transmission on the second subscription comprises:
determining whether the second subscription is engaged in a voice call; and
in response to determining that the second subscription is engaged in the voice call, determining whether one or more periods of silence are detected during the voice call on the second subscription; and
in response to determining that the one or more periods of silence are detected during the voice call on the second subscription, determining that the one or more gaps are present during the transmission on the second subscription.

17. A mobile communication device, comprising:
a first radio frequency (RF) chain associated with a first subscription;
a second RF chain associated with a second subscription; and
a control unit configured to:
determine that the mobile communication device is in a connected mode on the first subscription;
determine whether the second RF chain associated with the second subscription is available; and
in response to determining that the second RF chain associated with the second subscription is available, utilize the second RF chain associated with the second subscription to perform at least one of an inter-frequency measurement and an inter-radio access technology (RAT) measurement on the first subscription.

18. The mobile communication device of claim 17, wherein the control unit is further configured to determine that the mobile communication device is configured to operate in compressed mode (CM).

19. The mobile communication device of claim 17, wherein the at least one of the inter-frequency measurement and inter-RAT measurement comprises a measurement of a strength of a signal for an inter-frequency neighbor cell or an inter-RAT neighbor cell on the first subscription.

20. The mobile communication device of claim 17, wherein in response to determining that the second RF chain associated with the second subscription is available, the control unit is further configured to transmit a request to a first communication network to disable compressed mode (CM) on the first subscription.

21. The mobile communication device of claim 17, wherein in response to determining that the second RF chain associated with the second subscription is not available, the control unit is further configured to utilize a first RF chain associated with the first subscription to perform at least one of an inter-frequency measurement and an inter-RAT measurement on the first subscription.

22. The mobile communication device of claim 17, wherein to determine whether the second RF chain associated with the second subscription is available, the control unit is configured to:
determine whether the second subscription is in an idle mode; and
in response to determining that the second subscription is in the idle mode, determine that the second RF chain associated with the second subscription is available.

23. The mobile communication device of claim 22, wherein in response to determining that the second subscription is not in the idle mode, the control unit is further configured to:
determine whether one or more gaps are present during a transmission on the second subscription; and
in response to determining that the one or more gaps are present during the transmission on the second subscription, determine that the second RF chain associated with the second subscription is available.

24. The mobile communication device of claim 23, wherein to determine whether one or more gaps are present during a transmission on the second subscription, the control unit is configured to:
determine whether compressed mode (CM) is enabled on the second subscription; and
in response to determining that CM is enabled on the second subscription, determining that the one or more gaps are present during the transmission on the second subscription.

25. The mobile communication device of claim 23, wherein to determine whether one or more gaps are present during a transmission on the second subscription, the control unit is configured to:
determine whether the second subscription is engaged in a voice call; and
in response to determining that the second subscription is engaged in the voice call, determine whether a strength of a signal on the second subscription exceeds one or more thresholds; and
in response to determining that the signal strength on the second subscription exceeds the one or more thresholds, determine that the one or more gaps are present during the transmission on the second subscription.

26. The mobile communication device of claim 23, wherein to determine whether one or more gaps are present during a transmission on the second subscription, the control unit is configured to:
determine whether the second subscription is engaged in a voice call; and
in response to determining that the second subscription is engaged in the voice call, determine whether one or more periods of silence are detected during the voice call on the second subscription; and
in response to determining that the one or more periods of silence are detected during the voice call on the second subscription, determine that the one or more gaps are present during the transmission on the second subscription.

27. A mobile communication device, comprising:
means for determining that the mobile communication device is in a connected mode on a first subscription;
means for determining whether a second RF chain associated with a second subscription is available; and
in response to determining that the second RF chain associated with the second subscription is available, means for utilizing the second RF chain associated with the second subscription to perform at least one of an inter-frequency measurement and an inter-radio access technology (RAT) measurement on the first subscription.

28. A non-transitory computer readable medium having stored thereon instructions for causing one or more processors to perform operations comprising:
determining that a mobile communication device is in a connected mode on a first subscription;
determining whether a second RF chain associated with a second subscription is available; and
in response to determining that the second RF chain associated with the second subscription is available, utilizing the second RF chain associated with the second subscription to perform at least one of an inter-frequency measurement and an inter-radio access technology (RAT) measurement on the first subscription.
